(19) United States
(12) Patent Application Publication
(10) Pub. No.: US 2011/0307533 A1
(43) Pub. Date: Dec. 15, 2011

(54) Data managing system, data managing method, and computer-readable, non-transitory medium storing a data managing program

(75) Inventor: Toshiaki Saeki, Kawasaki (JP)

(73) Assignee: Fujitsu Limited, Kawasaki (JP)

(21) Appl. No.: 13/064,549

(22) Filed: Mar. 30, 2011

(30) Foreign Application Priority Data
Jun. 9, 2010 (JP) 2010-132343

(51) Int. Cl. G06F 17/30

(52) U.S. Cl. 707/822; 707/E17.005

(57) ABSTRACT

A data managing system includes data managing apparatuses storing data using a first storage unit and a second storage unit with a higher access speed than the first storage unit. Each data managing apparatuses includes an operation performing unit performing, upon reception of an operation request including a first identifier and a second identifier indicating an operation target performed before an operation target of the first identifier, an operation on first data corresponding to the first identifier; a prior-read request unit requesting a prior-read target data managing apparatus to store data corresponding to a third identifier in the second storage unit upon reception of the operation request; and a prior-read target registration request unit requesting the data managing apparatuses corresponding to the second identifier to store the first identifier as the prior-read target of the second identifier.

### CROSS-REFERENCE TO RELATED APPLICATIONS

This application is based upon and claims the benefit of priority of Japanese Patent Application 2010-132343, filed on Jun. 9, 2010, the entire contents of which are incorporated herein by reference.

### FIELD

The disclosures herein relate to data managing systems, data managing methods, and computer-readable, non-transitory media storing a data managing program for managing data in a distributed manner.

### BACKGROUND

In a DHT (Distributed Hash Table), hash values of keys (such as data names) corresponding to data (contents) are mapped onto a space which is divided and managed by plural nodes. Each of the nodes manages the data belonging to a space (hash value) allocated to the node in association with the keys, for example.

Using the DHT, a client can identify the node that manages target data with reference to the hash value of the key corresponding to the data, without inquiring the nodes. As a result, communication volumes can be reduced and the speed of data search can be increased. Further, because of the random nature of hash values, concentration of load in specific nodes can be avoided, thereby ensuring good scalability. The DHT also enables the setting up of a system using a number of inexpensive servers instead of an expensive server capable of implementing large-capacity memories. Further, the DHT is robust against random queries.

DHT technology, which allocates data to a number of nodes, does not define the manner of data management by the nodes. Each node of a DHT normally stores data based on a combination of a memory and a HDD (Hard Disk Drive). For example, when the total volume of management target data is large relative to the number of the nodes or the size of memory on each node, some of the data may be stored in the HDD.

However, HDD's are disadvantageous in that their random access latency is larger than that of memories. Thus, a HDD is not necessarily ideal for use with a DHT, whose strength lies in its robustness against random access. For example, if an HDD is utilized by each node of a DHT for storing data, the latency of the HDD manifests itself and the average data access speed decreases.

In a conventional data managing method, in order to hide the latency of the HDD, data with higher access frequencies are cached on memory. In another technique, data expected to be accessed next is pre-fetched on memory using access history and the like.
Patent Document 1: Japanese Laid-open Patent Publication No. 2008-191904

### SUMMARY

According to an embodiment, a data managing system includes plural data managing apparatuses configured to store data using a first storage unit and a second storage unit having a higher access speed than that of the first storage unit, each of the data managing apparatuses including an operation performing unit configured to perform, upon reception of an operation request including a first identifier indicating a first operation target and a second identifier indicating a second operation target performed before the first operation target, an operation on first data corresponding to the first identifier; a prior-read request unit configured to request one of the target data managing apparatuses corresponding to a third identifier to store data corresponding to the third identifier in the second storage unit upon reception of an operation request corresponding to the first identifier, the third identifier being stored in the data managing apparatus making the request as a prior-read target in the event of reception of the operation request corresponding to the first identifier; and a prior-read target registration request unit configured to request one of the data managing apparatuses corresponding to the second identifier to store the first identifier as the prior-read target of the second identifier.

In another embodiment, a data managing method performed by each of plural data managing apparatuses configured to store data using a first storage unit and a second storage unit having a faster access speed than that of the first storage unit includes receiving an operation request including a first identifier indicating a first operation target and a second identifier indicating a second operation target performed before the first operation target; performing an operation in response to the operation request on first data corresponding to the first identifier; requesting one of the data managing apparatuses corresponding to a third identifier to store data corresponding to the third identifier in the second storage unit upon reception of an operation request corresponding to the first identifier, the third identifier being stored in the data managing apparatus making the request as a prior-read target in the event of reception of the operation request corresponding to the first identifier; and requesting the data managing apparatus corresponding to the second identifier to store the first identifier as the prior-read target of the second identifier.

In another embodiment, a computer-readable, non-transitory medium stores a data managing program configured to cause each of plural data managing apparatuses having a first storage unit and a second storage unit having a higher access speed than the first storage unit to perform receiving an operation request including a first identifier indicating a first operation target and a second identifier indicating a second operation target performed before the first operation target; performing an operation in response to the operation request on first data corresponding to the first identifier; requesting one of the data managing apparatuses corresponding to a third identifier to store data corresponding to the third identifier in the second storage unit upon reception of an operation request corresponding to the first identifier, the third identifier being stored in the data managing apparatus as a prior-read target in the event of reception of the operation request corresponding to the first identifier; and requesting the data managing apparatus corresponding to the second identifier to store the first identifier as the prior-read target of the second identifier.

The object and advantages of the disclosure will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a data managing system according to an embodiment of the present invention;

FIG. 2 is a block diagram of a hardware structure of a DHT node according to an embodiment;

FIG. 3 illustrates a process performed in the data managing system according to an embodiment;

FIG. 4 illustrates the process performed in the data managing system according to the present embodiment, including a prefetching step;

FIG. 5 is a block diagram of a functional structure of the DHT node;

FIG. 6 is a block diagram of a functional structure of a client node;

FIG. 7 is a flowchart of a process performed by the client node;

FIG. 8 illustrates an operation history storage unit;

FIG. 9 is a flowchart of a process performed by the DHT node in accordance with an operation request;

FIG. 10 illustrates a data storage unit;

FIG. 11 is a flowchart of a process performed by the DHT node in accordance with a prefetch request; and

FIG. 12 is a flowchart of a process performed by the DHT node in accordance with a prefetch target registration request.

### DESCRIPTION OF EMBODIMENTS

It is difficult to hide the latency of an HDD by simply applying the aforementioned conventional data managing techniques to a DHT. Specifically, the cache effect is hard to obtain because DHT is basically adopted in applications where access frequencies are nearly uniform among various data. Further, accesses from clients are distributed among the nodes, so that even if the accesses have a strong correlation in terms of access order as a whole, correlation is very weak when observed on a node by node basis. Thus, the effect of pre-fetching on a closed node basis is limited. While it may be possible to share the history of access to the entire DHT among the nodes, the processing load for managing such access history and the communications load of the nodes for accessing the access history present a bottleneck, resulting in a loss of scalability.

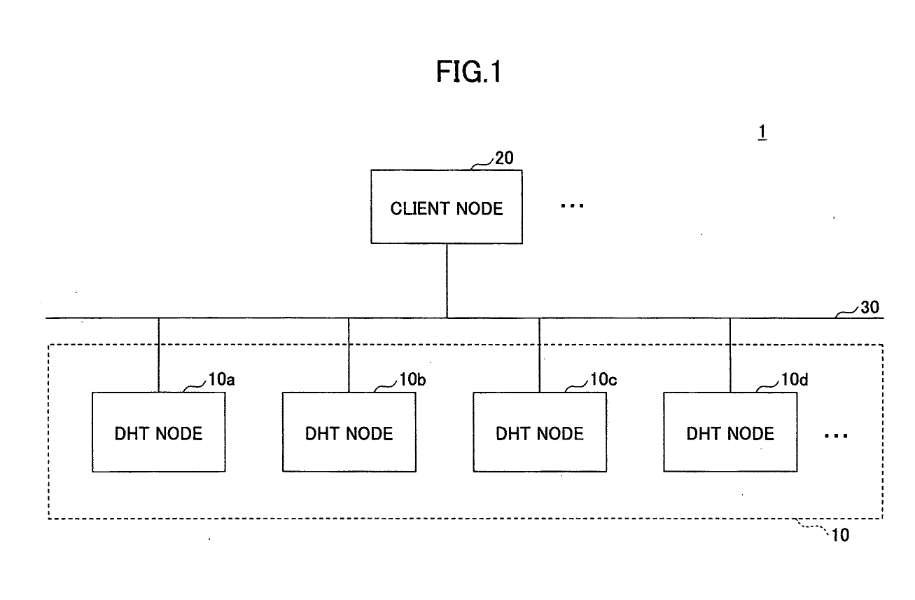

Embodiments of the present invention will be described with reference to the drawings. FIG. 1 is a block diagram of a data managing system 1 according to an embodiment of the present invention. The data managing system 1 includes DHT nodes 10 including DHT nodes 10a, 10b, 10c, and 10d, and one or more client nodes 20. The DHT nodes 10 and the client node 20 are connected to each other via a network 30 (which may be either wired or wireless), such as a LAN (Local Area Network) or the Internet, so that they can communicate with each other.

The DHT nodes 10a, 10b, 10c, and 10d function as data managing apparatuses and constitute a DHT (Distributed Hash Table). Namely, each DHT node 10 stores (manages) one or more items of data. Which DHT node 10 stores certain data is identified by a hash operation performed on identifying information of the data. In accordance with the present embodiment, a “key-value store” is implemented on each DHT node 10. The key-value store is a data base storing combinations of keys and values associated with the keys. From the key-value store, a value can be retrieved by providing a corresponding key. The keys include data identifying information. The values may include the substance of data. The keys may include a data name, a file name, a data ID, or any other information capable of identifying the data items. Data management on the DHT nodes 10 may be based on a RDB (Relational Database) instead of the key-value store. The type of data managed by the DHT nodes 10 is not particularly limited. Various other types of data may be used as management target data, such as values, characters, character strings, text data, image data, video data, audio data, and other electronic data.

The client node(s) 20 is a node that utilizes the data managed by the DHT nodes 10. In accordance with the present embodiment, the term “node” is basically intended to refer to an information processing apparatus (such as a computer). However, the node is not necessarily associated with a single information processing apparatus given the presence of information processing apparatuses equipped with plural CPUs and a storage unit for each CPU within a single enclosure.

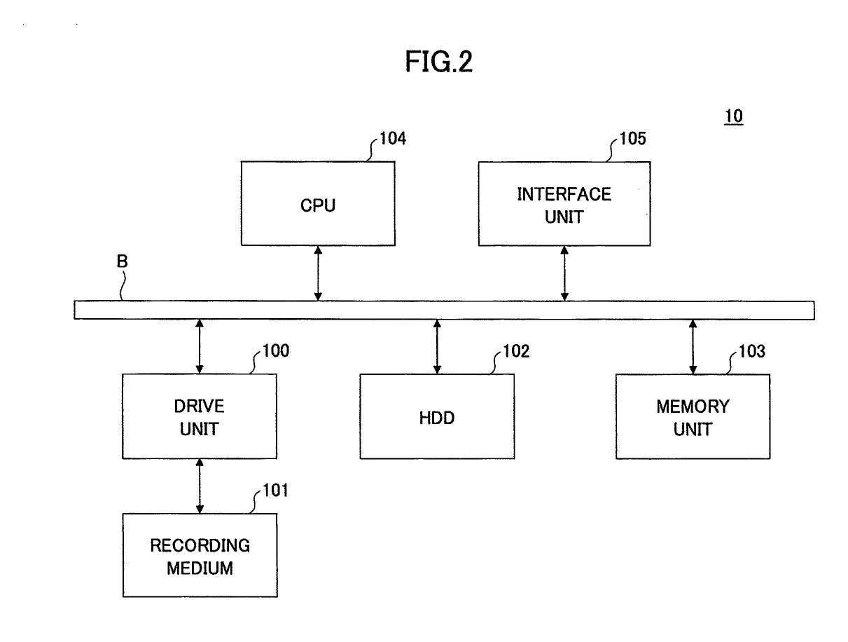

FIG. 2 is a block diagram of a hardware structure of the DHT node 10. The DHT node 10 includes a drive unit 100, a HDD 102, a memory unit 103, a CPU 104, and an interface unit 105 which are all connected via a bus B. A program for realizing a process in the DHT node 10 may be provided in the form of a recording medium 101, such as a CD-ROM. For example, when the recording medium 101 in which the program is recorded is set on the drive unit 100, the program is installed on the HDD 102 via the drive unit 100. Alternatively, the program may be downloaded from another computer via a network. The HDD 102 may store the installed program and management target data.

The memory unit 103 may include a RAM (random access memory) and store the program read from the HDD 102 in accordance with a program starting instruction. The memory unit 103 may also store data as a prefetch target. Thus, in accordance with the present embodiment, the DHT node 10 has a multilayer storage configuration using the HDD 102 and the memory unit 103. The HDD 102 is an example of a first storage unit of a lower layer. The memory unit 103 is an example of a second storage unit of a higher layer having a faster access speed (i.e., smaller latency) than the lower layer.

The CPU 104 may perform a function of the DHT node 10 in accordance with the program stored in the memory unit 103. The interface unit 105 provides an interface for connecting with a network. The hardware units of the DHT nodes 10a, 10b, 10c, and 10d may be distinguished by the alphabets at the end of the reference numerals of the corresponding DHT nodes 10. For example, the HDD 102 of the DHT node 10a may be designated as the HDD 102a. The client node 20 may have the same hardware structure as that illustrated in FIG. 2.

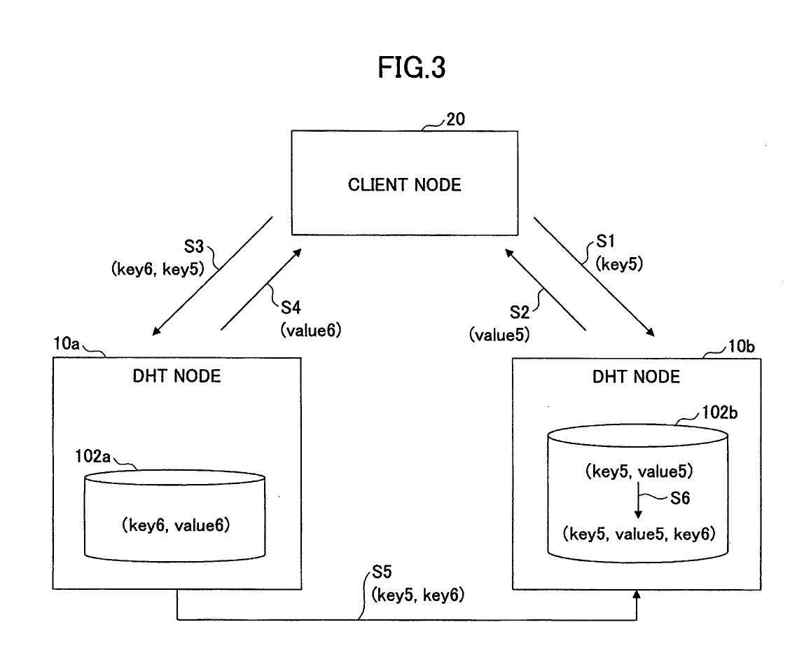

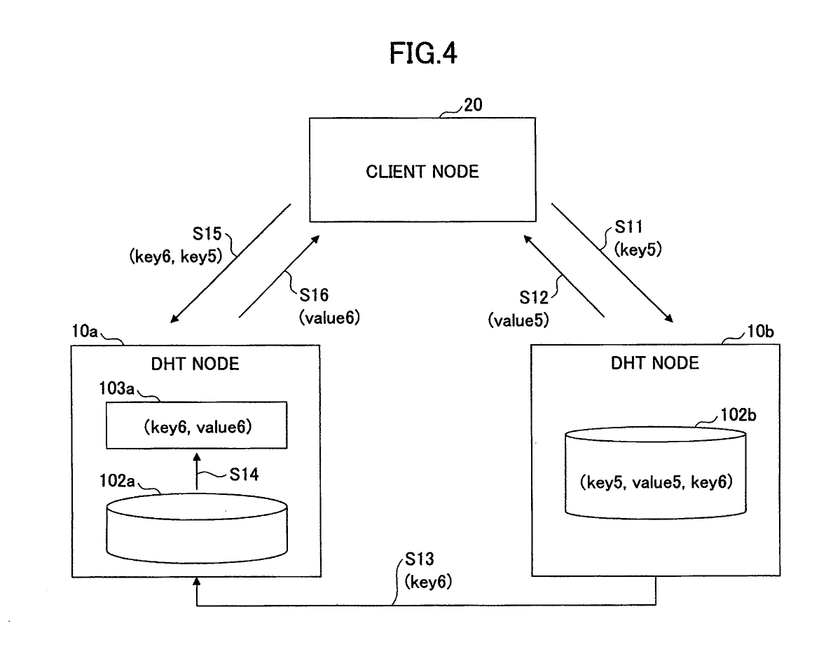

Next, a process performed by the data managing system 1 is described with reference to FIGS. 3 and 4. In the illustrated example, the DHT node 10a stores a value 6 (data) corresponding to a key 6. The DHT node 10b stores a value 5 (data) corresponding to a key 5. Each DHT node 10 of the data managing system 1 stores all data using the HDD 102 in an initial status (such as immediately after start-up). Thus, in the initial status (prior to step S1), the DHT nodes 10a and 10b store their values 6 and 5 in their respective HDD's 102a and 102b. On the other hand, the client node 20 is a node that utilizes the data corresponding to the key 6 after utilizing the data corresponding to the key 5.

In the data managing system 1, a process is performed as described below. First, the client node 20 identifies the DHT node 10b as a node that stores relevant data based on a result of operation of a predetermined hash function for the key 5. Thus, the client node 20 transmits a data operation request to the DHT node 10b while designating the key 5 (S1). The operation request is assumed to be a read request in the present example. Upon reception of the read request, the DHT node 10b reads the value 5 which is the data corresponding to the key 5 from the HDD 102b and sends the value back to the client 20 (S2).

Then, the client node 20, based on a result of operation of a predetermined hash function for the key 6, identifies the DHT node 10a as a node that stores relevant data. Thus, the client node 20 transmits a data read request to the DHT node 10a while designating the key 6 (S3). At this time, the read request also designates the key 5 of the data that has been operated just previously, in addition to the key 6 which is the key of the operation target data.

Upon reception of the read request, the DHT node 10a reads the value 6 which is the data corresponding to the key 6 from the HDD 102a and sends the data back to the client 20 (S4). Then, the DHT node 10a transmits a request (hereafter referred to as a “prefetch target registration request”) to the DHT node 10b, requesting the DHT node 10b to store the key 6 as a prefetch (prior-read) target upon reception of an operation request for the key 5. The “prefetch target” may be regarded as a candidate for the next operation target. The DHT node 10a identifies the DHT node 10b as a node corresponding to the key 5 based on a result of operation of a predetermined hash function for the key 5. The DHT node 10b, upon reception of the prefetch target registration request, stores the key 6 in association with the key 5 (S6). Namely, the DHT node 10b memorizes that it needs to prefetch the key 6 when the key 5 is an operation target.

Thereafter, the client node 20 again reads data in order of the keys 5 and 6 in a processing step illustrated in FIG. 4. In FIG. 4, steps S11 and S12 are similar to steps S1 and S2, respectively, of FIG. 3. However, after step S12, the DHT node 10b transmits the prefetch request for the key 6, which is stored as the prefetch target upon operation of the key 5 as a read target, to the DHT node 10a (S13). The DHT node 10b identifies the DHT node 10a as a node corresponding to the key 6 based on a result of operation of a predetermined hash function for the key 6.

The DHT node 10a, upon reception of the prefetch request, moves the value 6 corresponding to the key 6 from the HDD 102a to the memory unit 103a (S14). Namely, in accordance with the present embodiment, “prefetching” means the moving of data from the HDD 102 to the memory unit 103. “Moving” includes the process of deleting the copy source after copying. Thus, the data as a target of such moving is recorded at a destination (memory unit 103) and then deleted from the source of movement (such as the HDD 102) in order to avoid a redundant management of the same data.

Steps S15 and S16 are substantially identical to steps S3 and S4 of FIG. 3 with the exception that upon reception of the read request in step S15, the value 6 is moved to the memory unit 103 in the client 10a. Thus, it can be expected that the response of step S16 to step S15 is faster than the response of step S4 to step S3.

In the foregoing description, only two data items have been mentioned as operation targets (access targets) for convenience. When there is a large number of data items that constitute operation targets of the client 20, more prefetches may be performed and therefore more noticeable improvements in data access performance may be obtained.

While the foregoing description refers to an example in which one prefetch target is stored for each key (data item), plural prefetch targets may be stored for one key. Specifically, not just the next operation candidate but also two or more future operation candidates, such as the operation candidate after the next operation candidate or even the operation candidates after that, may be stored as prefetch targets in multiple levels. In such a case, all of the prefetch targets stored in multiple levels may be pre-fetched in parallel. As a result, the probability of the failure to prefetch data that should be pre-fetched may be reduced.

For example, in the case of FIG. 4, the operation request from the client node 20 (S15) may arrive before the prefetch request (S13). When the prefetch targets are stored in multiple levels, the data that is made the next operation target is pre-fetched with increased probability. Thus, further improvements in data access performance may be expected. Next, an example where the prefetch targets are stored in multiple levels (N levels) is described. When the prefetch target is limited to one target, this may be understood as a case of N=1.

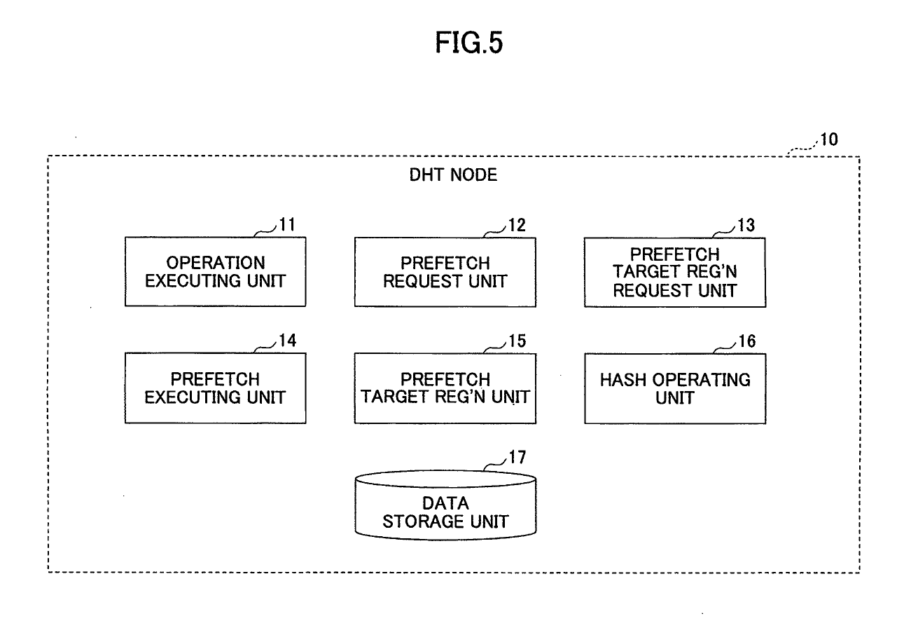

In order to realize the process described with reference to FIGS. 3 and 4, the DHT node 10 and the client node 20 have functional structures as described below. FIG. 5 is a block diagram of a functional structure of the DHT node 10. The DHT node 10 includes an operation performing unit 11, a prefetch request unit 12, a prefetch target registration request unit 13, a prefetch performing unit 14, a prefetch target registration unit 15, a hash operation unit 16, and a data storage unit 17. These units may be realized by a process performed by the CPU 104 in accordance with the program installed on the DHT node 10.

The operation performing unit 11, in response to an operation request from the client node 20, performs a requested operation on the data corresponding to the key designated in the operation request. The type of operation is not limited to the general operations such as reading (acquiring), writing (updating), or deleting. The type of operation may be defined as needed in accordance with the type of the management target data or its characteristics. For example, an operation relating to the processing or transformation of data may be defined. When the data includes values, the processing may involve the four arithmetic operations.

The prefetch request unit 12 performs the prefetch request transmit process described with reference to FIG. 4. The prefetch target registration request unit 13 performs the prefetch target registration request transmit process described with reference to FIG. 3. The prefetch performing unit 14 performs prefetching of the data corresponding to the key designated in the prefetch request in response to the request. The prefetch target registration unit 15 performs a process of registering the prefetch target in accordance with the prefetch target registration request. The hash operation unit 16 applies a predetermined hash function for the inputted key and outputs identifying information of the DHT node 10 corresponding to the key as a result of operation of the hash function. Thus, the hash function enables the identification of the DHT node 10 corresponding to the key. Therefore, the hash function (h) may be defined as follows:

h (key)=Node identifying information

For example, when the DHT node 10 can be identified by an IP address, the hash function h may be defined as follows:

h (key)=IP address

When plural processes have opened TCP/IP ports on the DHT node 10 and it is necessary to distinguish the process for causing the information processing apparatus to function as the DHT node 10 from other processes, the hash function h may be defined as follows:

h (key)=(IP address, port number)

The above are examples of how the node may be identified. The DHT node 10 may be identified by other methods, such as those described in publications relating to the DHT art.

The data storage unit 17 stores the management target data in association with the keys. For the key of which a prefetch target is registered, the data storage unit 17 may also store the key of the prefetch target in association. The data storage unit 17 may be realized using the HDD 102 and the memory unit 103. Thus, the pre-fetched data is stored in the memory unit 103 while the data that is not pre-fetched is stored in the HDD 102.

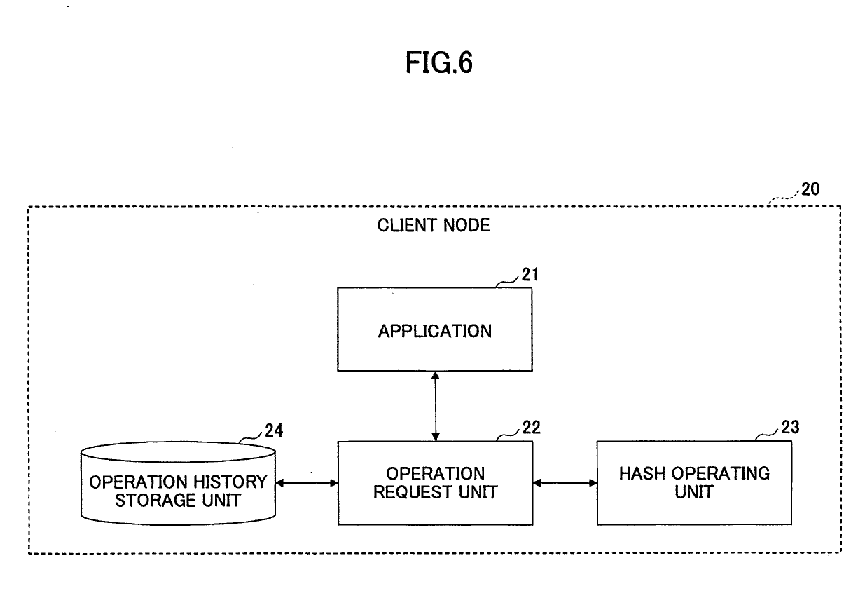

FIG. 6 is a block diagram of a functional structure of the client node 20. The client node 20 includes an application 21, an operation request unit 22, a hash operation unit 23, and an operation history storage unit 24. These units may be realized by a process performed by the CPU of the client node 20 in accordance with the program installed on the client node 20.

The application 21 includes a program that utilizes data. The application 21 may include an application program utilized by a user in a dialog mode, or an application program, such as the Web application 21, that provides a service in accordance with a request received via a network. The operation request unit 22 performs a process in accordance with the data operation request from the application 21. The hash operation unit 23 identifies the DHT node 10 corresponding to the key using the above hash function h. The operation history storage unit 24 stores a history of the key of the operation target data using the storage unit of the client node.

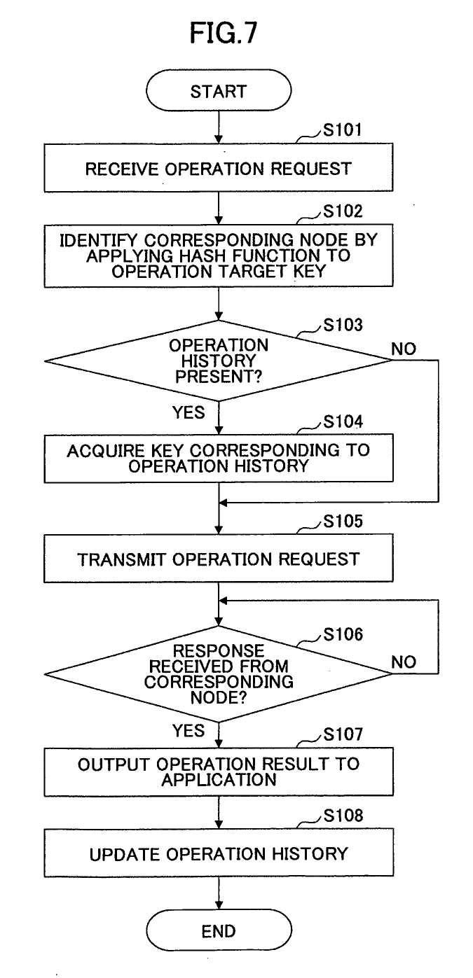

Next, processes performed in the client node 20 and the DHT node 10 are described. FIG. 7 is a flowchart of a process performed by the client node 20. In step S101, the operation request unit 22 receives a data operation request from the application 21. The operation request designates an operation target key (which may be referred to as a “target key”). The hash operation unit 23 then applies the hash function h to the target key and identifies the DHT node 10 (which may be hereafter referred to as a “corresponding node”) corresponding to the target key (S102). For example, the hash operation unit 23 outputs identifying information of the corresponding node, such as its IP address or port number, or both.

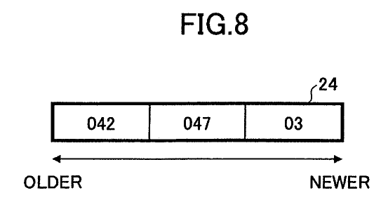

Thereafter, the operation request unit 22 determines the presence or absence of an entry (operation history) in the operation history storage unit 24 (5103). FIG. 8 illustrates an example of an operation history storage unit 24. In this example, the operation history storage unit 24 has a FIFO (First-In First-Out) list structure and stores the keys as operation targets of the past N operations in order of operation. The three values “042”, “047”, and “03” indicate the keys used as operation targets in the past three operations. The value of N (i.e., the size of the operation history storage unit 24) is determined by a storage range of prefetch targets corresponding to one key. When the storage range of prefetch targets has one level, the key corresponding to the past one (i.e., immediately prior) operation may be stored. Thus, the operation history storage unit 24 may be configured to store one key. In accordance with the present embodiment, the prefetch target storage range has three levels, so that the keys corresponding to the past three operations are stored.

The determination in step S103 determines whether there is at least one key recorded in the operation history storage unit 24. When at least one key is recorded in the operation history storage unit 24 (“Yes” in S103), the operation request unit 22 acquires all of the keys recorded in the operation history storage unit 24 (S104). The acquired keys may be referred to as “history keys”.

Thereafter, the operation request unit 22 transmits an operation request to the corresponding node based on the identifying information outputted by the hash operation unit 23 (S105). The operation request may designate an operation type, a target key, and all of history keys. When there are plural history keys, the operation request may include information designating an order relationship or operation order of the keys. For example, the history keys may be designated by a list structure corresponding to the operation order.

The operation request unit 22 then waits for a response from the corresponding node (S106). Upon reception of a response from the corresponding node (“Yes” in S106), the operation request unit 22 outputs an operation result included in the response to the application 21 (S107). For example, when the operation type indicates reading (acquisition), data corresponding to the target key is outputted to the application 21 as an operation result.

The operation request unit 22 then records the target key in the operation history storage unit 24 (S108). When the total number of keys that can be stored in the operation history storage unit 24 is exceeded by the recording of the target key, the oldest key may be deleted from the operation history storage unit 24.

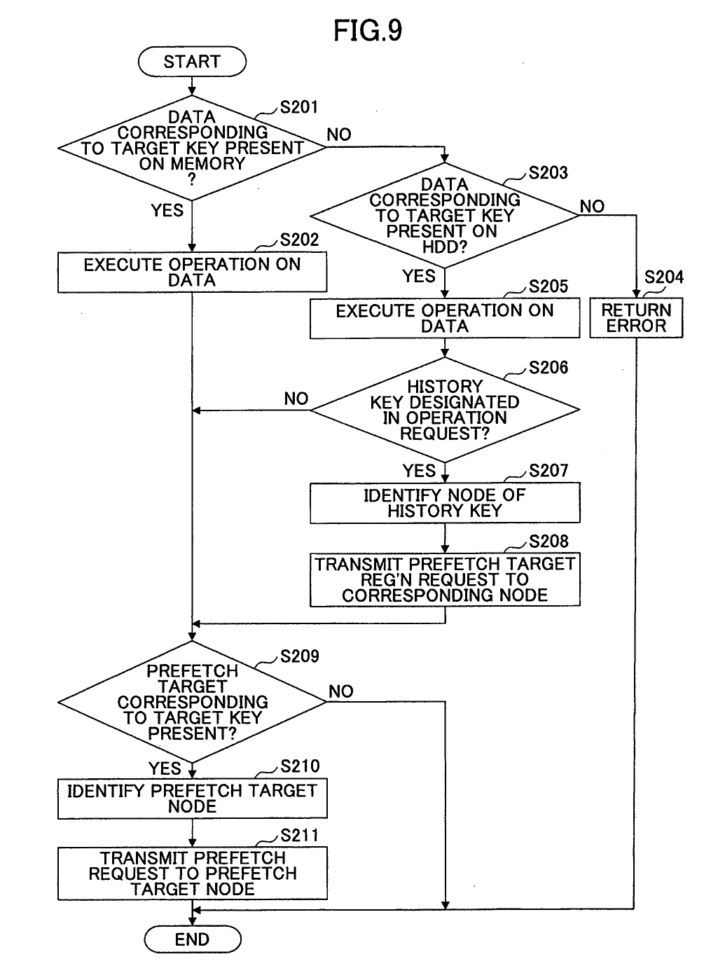

Next, a process performed by the DHT node 10 upon reception of the operation request from the client node 20 is described. FIG. 9 is a flowchart of the process. Upon reception of the operation request from the client node 20, the operation performing unit 11 determines whether a record in the data storage unit 17 corresponding to the target key designated in the operation request is loaded (pre-fetched) in the memory unit 103 (S201).

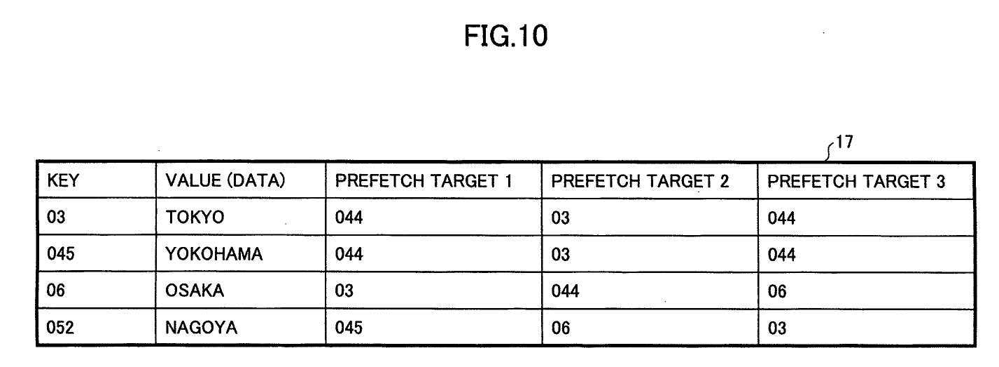

FIG. 10 illustrates a structure of the data storage unit 17. In the illustrated example, the data storage unit 17 stores records including a key, a value (data), and prefetch targets 1 through 3, for each data managed by the DHT node 10. In the illustrated example, the data include character strings. The prefetch target N (N being 1, 2, or 3) indicates the key of data that is pre-fetched when the key of a relevant record (more strictly, data corresponding to the key) is made an operation target. The value of N indicates the order (order) allocated to the prefetch target. Namely, the prefetch target is tied to an order when stored. The order is used as a prefetch order. However, prefetches may be performed in parallel. The prefetch target N is registered based on an operation order in the past operation history. For example, 044, 03, and 044 are registered in the prefetch target N of the record in the first line (the record corresponding to the key 03) because operations were performed in order of 044, 03, and 044 after operation of data with the key 03. The prefetch target may not be stored in the same table as that of data as long as the prefetch target is associated with the key.

While the illustrated example shows a single table, the physical storage locations of the records of the data storage unit 17 may vary. For example, some of the records may be stored in the HDD 102 while the other records may be loaded (pre-fetched) onto the memory unit 103. Therefore, it is determined in step S201 whether there is a record corresponding to the target key among the records pre-fetched in the memory unit 103.

When a corresponding record is pre-fetched in the memory unit 103 (“Yes” in S201), the operation performing unit 11 performs an operation corresponding to the operation type designated in the operation request on the data contained in the record (S202). For example, when the operation type indicates reading (acquiring), the operation performing unit 11 sends the acquired data to the client node 20.

On the other hand, when the corresponding record is not in the memory unit 103 (“No” in S201), the operation performing unit 11 determines whether the record corresponding to the target key is stored in the HDD 102 (5203). When the corresponding record is not stored in the HDD 102 either (“No” in S203), the operation performing unit 11 returns an error to the client node 20 (S204).

When the corresponding record is stored in the HDD 102 (“Yes” in S203), the operation performing unit 11 performs an operation corresponding to the operation type designated in the operation request on the data included in the record (S205). The record corresponding to the data of the operation target (record in the data storage unit 17) may be moved to the memory unit 103.

Thereafter, the prefetch target registration request unit 13 determines whether a history key is designated in the operation request (S206). When the history key is designated (“Yes” in S206), the prefetch target registration request unit 13 identifies the DHT node 10 (history node) corresponding to the history key by utilizing the hash operation unit 16 (S207). Namely, when the target key is inputted to the hash operation unit 16, the hash operation unit 16 outputs the identifying information of the history node (such as IP address).

Then, the prefetch target registration request unit 13 transmits a prefetch target registration request to the history node so that the target key is registered as a prefetch target (S208). The prefetch target registration request may designate all of history keys designated in the operation request in addition to the target key. When there are plural history keys, the prefetch target registration request may also include information designating an order relationship or operation order of the history keys. For example, the history keys are designated by a list structure corresponding to the operation order. The history node may potentially be the corresponding node (i.e., the node that transmitted the prefetch target registration request). When there are plural history keys, steps S207 and S208 are performed for each history key, either serially in accordance with the operation order of the history keys or in parallel.

In accordance with the present embodiment, as will be seen from the process after step S203, when the data corresponding to the operation target is stored in the HDD 102 (i.e., not pre-fetched), a prefetch target registration request is transmitted. However, this does not exclude the case where the prefetch target registration request is transmitted when the data corresponding to the operation target is stored in the memory unit 103. However, by limiting the opportunity for transmitting the prefetch target registration request to the case where the operation target data is stored in the HDD 102, an increase in the volume of communications between the DHT nodes 10 may be prevented.

After step S202 or S208, the prefetch performing unit 14 determines whether the prefetch target is registered in the record corresponding to the target key (S209). When the prefetch target is registered in the record, the prefetch performing unit 14 identifies the DHT node 10 (prefetch target node) corresponding to the prefetch target by utilizing the hash operation unit 16 (S210). Thereafter, the prefetch performing unit 14 transmits a prefetch request to the prefetch target node (S211). The prefetch request designates the key of the prefetch target corresponding to the prefetch target node. When plural prefetch targets are registered in the record corresponding to the target key (operation target key), steps S210 and S211 may be performed for each prefetch target either serially in accordance with the operation order of the prefetch target or in parallel. However, the client node 20 may next operate the prefetch target 1 with a higher probability. Thus, preferably, the prefetch request for the prefetch target 1 is not later than the prefetch request for the prefetch target 2 or 3. The prefetch target node may possibly be the corresponding node (i.e., the node that transmitted the prefetch target registration request).

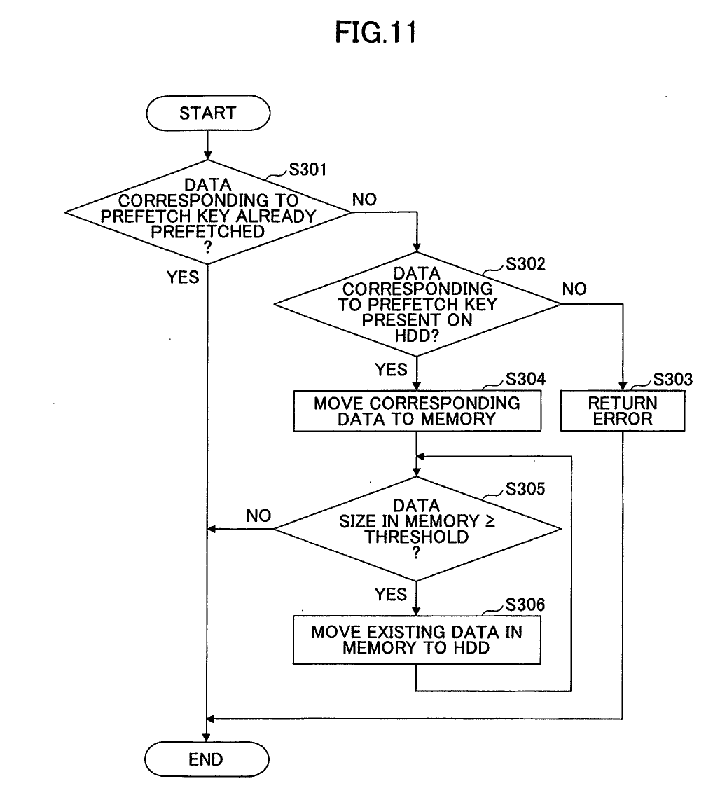

Next, a process performed by the DHT node 10 in response to the prefetch request transmitted in step S210 is described. FIG. 11 is a flowchart of the process. Upon reception of the prefetch request, the prefetch performing unit 14 determines whether the record corresponding to the key (“prefetch key”) of the prefetch target designated in the prefetch request is already pre-fetched (S301). Namely, whether the corresponding record is present in the memory unit 103 is determined.

When the corresponding record is in the memory unit 103 (“Yes” in S301), the process of FIG. 11 is terminated. When the corresponding record is not in the memory unit 103 (“No” in S301), the prefetch performing unit 14 determines whether the record corresponding to the prefetch key is stored in the HDD 102 (S302). When the corresponding record is not recorded in the HDD 102 either (“No” in S302), the prefetch performing unit 14 returns an error (S303).

When the corresponding record is in the HDD 102 (“Yes” in S302), the prefetch performing unit 14 moves the record to the memory unit 103 (S304). Thereafter, the prefetch performing unit 14 determines whether the total data size of the records in the data storage unit 17 stored in the memory unit 103 is equal to or more than a predetermined threshold value (S305). When the total data size is equal to or more than the predetermined threshold value (“Yes” in S305), the prefetch performing unit 14 moves one of the records in the memory unit 103 to the HDD 102 (S306). The one record may be the record whose timing of the last operation is the oldest. Thus, the one record may be selected based on a LRU (Least Recently Used) algorithm. However, other cache algorithms may be used. Steps S305 and S306 are repeated until the total data size is less than the predetermined threshold value.

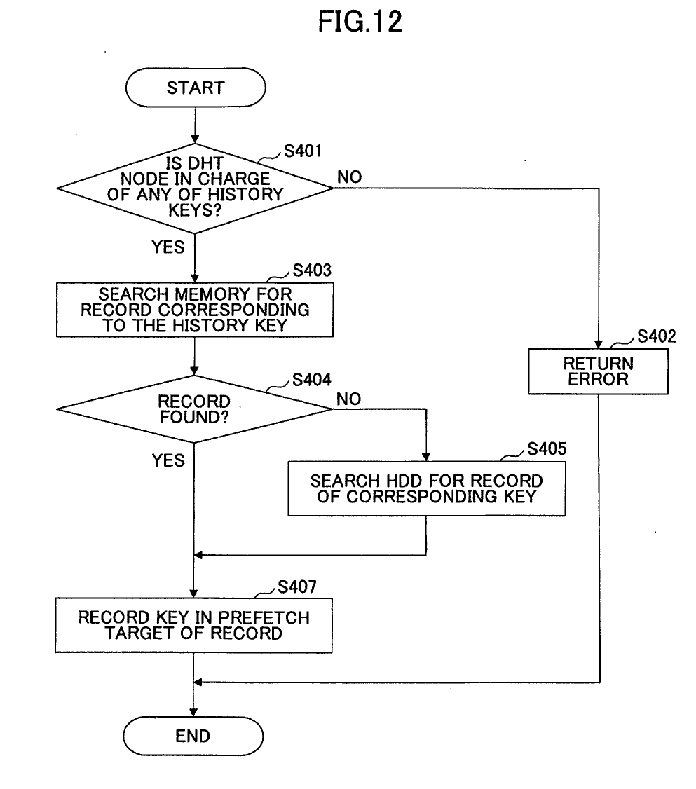

Next, a process performed by the DHT node 10 upon reception of the prefetch target registration request transmitted in step S208 of FIG. 9 is described. FIG. 12 is a flowchart of an example of the process. Upon reception of the prefetch target registration request, the prefetch target registration unit 15 determines if there is a history key that the DHT node 10 is in charge of storing, among the one or more history keys designated in the prefetch target registration request (S401). For example, it is determined whether any of the history keys is recorded in the key item of the data storage unit 17.

When there is no history key that the DHT node 10 is in charge of recording (“No” in S401), the prefetch target registration unit 15 returns an error (S402). When there is at least one history key that the DHT node 10 is in charge of recording (“Yes” in S401), the prefetch target registration unit 15 searches the memory unit 103 for the record corresponding to the history key (S403). When the record cannot be retrieved (“No” in S404), the prefetch target registration unit 15 searches the HDD 102 for the record corresponding to the history key (S405).

Then, the prefetch target registration unit 15 records the target key designated in the prefetch target registration request in the prefetch target N of the corresponding record retrieved from the memory unit 103 or the HDD 102 (S406). When there are plural history keys that the DHT node 10 is in charge of recording, steps S403 through S406 may be performed for each history key.

When plural (N) prefetch targets are stored for each key according to the present embodiment (see FIG. 10), the value of N given to the target key in step S406 may be determined based on the information indicating the order relationship of the history keys designated in the prefetch target registration request. The value of N given to the target key indicates in which of the prefetch targets 1, 2, and 3 the target key is registered.

The order relationship of the history keys indicates the operation history in the immediate past of the target key. Namely, the first in the order relationship is the oldest and the last is the newest. Thus, the closer the history key is to the end of the order relationship, the less the distance from the target key in the operation history. Thus, the value N given to the target key may be determined as follows:

N=S−“distance of the target history key from the end of the order relationship of the history key”+1, where S is the number of levels of the prefetch targets, which is three in the present embodiment. The “distance of the target history key from the end of the order relationship of the history key” is a value obtained by subtracting the order of the target history key from the last order of the order relationship.

For example, when three history keys are designated in the prefetch target registration request and the history key that the DHT node 10 is in charge of is the third one, the target key is recorded in the prefetch target 1. When the history key that the DHT node 10 is in charge of is the second one, the target key is recorded in the prefetch target 2. When the history key that the DHT node 10 is in charge of is the first one, the target key is recorded in the prefetch target 3. When one history key is designated in the prefetch target registration request, the target key is recorded in the prefetch target 1 because in this case the distance of the history key from the end is zero.

The target key is written over the prefetch target N. Namely, the key that has previously been recorded in the prefetch target N is deleted. However, multiple keys may be stored in each of the prefetch targets 1 through 3 (i.e., in the order of each prefetch target). For example, two or more keys may be stored in each of the prefetch targets 1 through 3 of one record. In this case, the existing prefetch targets may not be deleted as long as the number of the multiple keys does not exceed a predetermined number (“multiplicity”) of the prefetch target.

If the multiplicity is exceeded, keys may be deleted from the oldest ones. When the prefetch targets have such multiplicity, the prefetch requests may be transmitted for as many keys as the multiplicity×the number of levels. In this way, further improvements in data access speed may be expected.

Thus, in accordance with the present embodiment, prefetching can be realized for a data operation performed across the DHT nodes 10. As a result, latency of the HDD 102 can be hidden, so that the average data access speed can be increased. The type of operation is not limited to reading (acquiring) because it may be faster to access the memory unit 103 than the HDD 102 for various operations. Compared to the case where an operation history of the entire DHT is shared by the nodes, the processing load and communications load of the DHT nodes 10 can be reduced. Because the step of referencing the prefetch target is simple, fast prefetching for the next operation by the client node 20 can be realized.

In accordance with the present embodiment, the operation request designates history keys corresponding to a few, immediately preceding operations, and keys corresponding to a few, immediately subsequent operations are recorded as the prefetch target. However, the history keys designated in the operation request are not limited to such immediately preceding operations. For example, a history key corresponding to the operation before last or even earlier operations may be designated. In this case, a key that is made an operation target for the operation after next or later operations may be stored as a prefetch target. The plural history keys designated in the operation request may not have a sequential relationship in the operation history. For example, the plural history keys may have an alternate relationship. In this case, the every-other operation target keys may be stored as the prefetch targets.

In accordance with the present embodiment, the client node 20 may not include the function of identifying the DHT node 10 based on a key. For example, the client node 20 may transmit various requests to any of the DHT nodes 10. In this case, if the DHT node 10 is not in charge of the key designated in the request upon reception of a request, the DHT node 10 may transfer the request to the node corresponding to the key. Alternatively, the client node 20 may inquire any of the DHT nodes 10 about the IP address and port number of the node corresponding to the key. In this case, the DHT node 10 that has received such an inquiry may return the IP address and port number of the node corresponding to the key.

The network for communications between the client node 20 and the DHT node 10 and the network for communications among the DHT nodes 10 may be physically separated. In this way, the client node 20 can be prevented from being affected by the communications among the DHT nodes 10 for prefetching across the DHT nodes 10.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention.

Although the embodiments of the present inventions have been described in detail, it should be understood that the various changes, substitutions, and alterations could be made hereto without departing from the spirit and scope of the invention.

What is claimed is:

1. A data managing system comprising
data managing apparatuses configured to store data using a first storage unit and a second storage unit having a higher access speed than that of the first storage unit,
each of the data managing apparatuses including
an operation performing unit configured to perform, upon reception of an operation request including a first identifier indicating a first operation target and a second identifier indicating a second operation target performed before the first operation target, an operation in accordance with the operation request on first data corresponding to the first identifier;
a prior-read request unit configured to request one of the data managing apparatuses corresponding to a third identifier to store data corresponding to the third identifier in the second storage unit, the third identifier being stored in the data managing apparatus making the request as a prior-read target in the event of reception of the operation request corresponding to the first identifier; and
a prior-read target registration request unit configured to request one of the data managing apparatuses corresponding to the second identifier to store the first identifier as the prior-read target of the second identifier.

2. The data managing system according to claim 1, wherein the prior-read target registration request unit is configured to request that the first identifier be stored as the prior-read target corresponding to the second identifier when the first data is stored in the first storage unit.

3. The data managing system according to claim 1, wherein the operation request includes the second identifier of each of the second operation targets performed before the first operation target,
wherein the prior-read request unit is configured to request each of the data managing apparatuses corresponding to the third identifiers to record the data corresponding to the third identifier in the second storage unit,
wherein the prior-read target registration request unit is configured to request each of the data managing apparatuses corresponding to the second identifier to store the first identifier as the prior-read target of the second identifier.

4. The data managing system according to claim 3, wherein the operation request includes information of the second identifier of each of the second operation targets performed before the first operation target and an order relationship of operations corresponding to the second operation targets,
wherein the prior-read request unit is configured to request each of the data managing apparatuses corresponding to the third identifiers stored with order information to record the data corresponding to the third identifiers in the second storage unit in accordance with the order information,
wherein the prior-read target registration request unit is configured to request each of the data managing apparatuses corresponding to the second identifier to store, as the prior-read target of the second identifier, the first identifier in accordance with the order information based on the order relationship with the second identifier.

5. The data managing system according to claim 1, wherein, upon reception of the request to store the first identifier as the prior-read target of the second identifier from the prior-read registration request unit, the data managing apparatus stores the first identifier together with a fourth identifier in accordance with the same order information as that of the fourth identifier, the fourth identifier corresponding to another data already stored as the prior-read target of the second identifier.

6. A data managing method performed by each of data managing apparatuses configured to store data using a first storage unit and a second storage unit having a faster access speed than that of the first storage unit, the data managing method comprising:
receiving an operation request including a first identifier indicating a first operation target and a second identifier indicating a second operation target performed before the first operation target;
performing an operation in response to the operation request on first data corresponding to the first identifier;
requesting one of the data managing apparatuses corresponding to a third identifier to store data corresponding to the third identifier in the second storage unit, the third identifier being stored in the data managing apparatus making the request as a prior-read target in the event of reception of the operation request corresponding to the first identifier; and
requesting the data managing apparatus corresponding to the second identifier to store the first identifier as the prior-read target of the second identifier.

7. The data managing method according to claim 6, wherein the requesting the data managing apparatus corresponding to the third identifier includes, when the first data is stored in the first storage unit, to store the first identifier as the prior-read target of the second identifier.

8. The data managing method according to claim 6, wherein the operation request includes the second identifier of each of the second operation targets performed before the first operation target,
wherein the requesting the data managing apparatus corresponding to the third identifier includes requesting each of the data managing apparatuses corresponding to the third identifiers to record the data corresponding to the third identifier in the second storage unit,
wherein the requesting the data managing apparatus corresponding to the second identifier includes requesting each of the data managing apparatuses corresponding to the second identifier to store the first identifier as the prior-read target of the second identifier.

9. The data managing method according to claim 8, wherein the operation request includes information indicating the second identifier of each of the second operation targets performed before the first operation target and an order relationship of operations corresponding to the second operation targets,
wherein the requesting the data managing apparatus corresponding to the third identifier includes requesting each of the data managing apparatuses corresponding to the third identifiers stored with order information to store the data corresponding to the third identifier in the second storage unit in accordance with the order information,
wherein the requesting the data managing apparatus corresponding to the second identifier includes requesting each of the data managing apparatuses corresponding to the second identifier to store, as the prior-read target corresponding to the second identifier, the first identifier in accordance with the order information based on the order relationship with the second identifier.

10. The data managing method according to claim 6, wherein, upon reception of the request for storing the first identifier as the prior-read target of the second identifier in the requesting the data managing apparatus corresponding to the second identifier, the first identifier is stored together with a fourth identifier in accordance with the same order information as that of the fourth identifier, the fourth identifier corresponding to another data already stored as the prior-read target of the second identifier.

11. A computer-readable, non-transitory medium storing a data managing program configured to cause each of data managing apparatuses having a first storage unit and a second storage unit having a higher access speed than the first storage unit to perform:
receiving an operation request including a first identifier indicating a first operation target and a second identifier indicating a second operation target performed before the first operation target;
performing an operation in response to the operation request on first data corresponding to the first identifier;
requesting one of the data managing apparatuses corresponding to a third identifier to store data corresponding to the third identifier in the second storage unit, the third identifier being stored in the data managing apparatus making the request as a prior-read target in the event of reception of the operation request corresponding to the first identifier; and
requesting the data managing apparatus corresponding to the second identifier to store the first identifier as the prior-read target of the second identifier.

12. The computer-readable, non-transitory medium according to claim 11, wherein the requesting the data managing apparatus corresponding to the second identifier includes, when the first data is stored in the first storage unit, requesting storage of the first identifier as the prior-read target of the second identifier.

13. The computer-readable, non-transitory medium according to claim 11, wherein the operation request includes the second identifier of each of the second operation targets performed before the first operation target,
wherein the requesting the data managing apparatus corresponding to the third identifier includes requesting each of the data managing apparatuses corresponding to the third identifiers to store the data corresponding to the third identifier in the second storage unit,
wherein the requesting the data managing apparatus corresponding to the second identifier includes requesting each of the data managing apparatuses corresponding to the second identifier to store the first identifier as the prior-read target of the second identifier.

14. The computer-readable, non-transitory medium according to claim 13, wherein the operation request includes information indicating the second identifier of each of the second operation targets performed before the first operation target and an order relationship of operations corresponding to the second operation targets,
wherein the requesting the data managing apparatus corresponding to the third identifier includes requesting each of the data managing apparatuses corresponding to the third identifiers stored with order information to store the data corresponding to the third identifier in the second storage unit in accordance with the order information,
wherein the requesting the data managing apparatus corresponding to the second identifier includes requesting each of the data managing apparatuses corresponding to the second identifier to store, as the prior-read target corresponding to the second identifier, the first identifier in accordance with the order information based on the order relationship with the second identifier.

15. The computer-readable, non-transitory medium according to claim 11, wherein, upon reception of the request for storing the first identifier as the prior-read target of the second identifier in the requesting the data managing apparatus corresponding to the second identifier, the first identifier is stored together with a fourth identifier in accordance with the same order information as that of the fourth identifier, the fourth identifier corresponding to another data already stored as the prior-read target of the second identifier.
